(19) United States
(12) Patent Application Publication
(10) Pub. No.: US 2005/0213598 A1
(43) Pub. Date: Sep. 29, 2005

(54) APPARATUS AND METHOD FOR TUNNELING AND BALANCING IP TRAFFIC ON MULTIPLE LINKS

(76) Inventors: Yucheng Lin, Taipei County (TW); Yung Yih, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/907,242

(22) Filed: Mar. 25, 2005

(30) Foreign Application Priority Data
Mar. 26, 2004 (TW) 93108233

(51) Int. Cl. H04L 12/28

(52) U.S. Cl. 370/437

(57) ABSTRACT

An apparatus and method for processing a packet are provided. They are adapted for plural network packet transmissions. The apparatus for processing the packet comprises a memory, a tunnel-selection module and a tunnel-checking module. The memory stores tunnels and weights corresponding thereto. The tunnel-selection module selects one of the tunnels according to the weights to transmit the packet. The tunnel-checking module checks linking relationship between the apparatus and the networks and adjusts tunnels data stored in the memory. Accordingly, the packet transmission system with tunnels can perform fault tolerance and loading balancing.

### CROSS-REFERENCE TO RELATED APPLICATION

This application claims the priority benefit of Taiwan application serial no. 93108233, filed on Mar. 26, 2004.

### BACKGROUND OF THE INVENTION

1. Field of the Invention

The present invention relates to a tunnel system among local area networks, and more particularly, to an apparatus and method for processing a packet between a single or plural networks, and plural network service providers so as to tunnel and balance internet protocol (IP) traffic on multiple links.

2. Description of the Related Art

In the prior art technology, plural links provided by a network service provider are used to connect a single or plural area networks and a single apparatus of the network service provider. By setting the table between the apparatus and the router of the network service provider, the packets can be correctly transmitted from the apparatus to the desired receiver apparatuses of networks through different links, vice versa. In the prior art technology, the update of the table of the router of the network service provider is required so that the connectivity between the apparatus and the network will not be affected by some failed link circuits. Accordingly, the packets can be transmitted without loss or errors. If the network of the network service provider, however, fails, the links will not provide normal network connectivity services. That increases costs and causes inconvenience to users. Thus, multiple links to multiple network service providers to maintain the uninterrupted network service for enterprises and and institutions are very important.

While multiple links with some network service providers are used, some issues in the prior art technology remain unsolved. The main issue of the present technology results from the packet headers carrying the public internet protocol (IP) addresses, which are assigned by the network interface of the transmission apparatus. Under normal situation, the addresses assigned by the network interface are provided by the network service providers so that the router of the network service provider correctly transmits the packets from the interface to the desired receiver apparatus. Of course, the receiver apparatus correctly sends the reply packet to the transmission apparatus as well. If the link is interrupted, links and therefore addresses of the other network service provider are used. However, the new network address will be identified as an invalid address when the packet is received by the receiver apparatus. If, on the other hand, the address provided by the original network service provider is used, the packet may be disregarded by the router of the new network service provider. Even if the packet is not disregarded and transmitted to the correct receiver apparatus, the packet replied by the receiver apparatus cannot be transmitted to the sending apparatus due to the failed link.

Accordingly, the multiple links with the network service providers provide few advantages. Regarding the fault tolerance, the tunnel system provided by the single network service provider may have some fault tolerance; whereas the tunnel system of the multiple network service providers cannot tolerate any error. In addition, when the link in the tunnel system established by a specific network application is bound to a specific route, the packet cannot be transmitted through other routes. That wastes the network bandwidth and restricts the use of available bandwidth in other links by the network application. Meanwhile, multiple network software related to the tunnels competes for the priority of the specific route, which also reduces the software execution performance and fail user's requirements. Under this circumstance, the tunnel system does not have the loading balance capability. Accordingly, how to improve the tunnel system for end users and network service providers becomes a very essential topic.

### SUMMARY OF THE INVENTION

Accordingly, the present invention is directed to a method of tunneling and balancing IP traffics on multiple links. According to the method, an apparatus coupled to a plurality of links of networks transmits packets of the tunnel system to one of the tunnels built on the links of the networks coupled to the apparatus. By using the packet transmission mechanism of the tunnel system according to the present invention, each packet transmission in the tunnel system is independent from the connectivity of the different links and networks. Thus, the issue existed in the prior art technology can be solved.

The present invention combines the technique and principle of a selection algorithm and of a packet encapsulation. For each packet which is to be transmitted in the tunnel system according to the selection algorithm, a tunnel and the network links used for the tunnel are selected so as to encapsulate the packet. The encapsulated packet can be correctly transmitted to the receiver apparatus through the network sponsored by the selected network service provider. After removing the packet header which was successfully passed through the network by the network service provider, the receiver apparatus correctly responds to the packet.

The present invention provides an apparatus for processing a packet. The apparatus for processing the packet comprises a memory, a tunnel-selection module and a tunnel-checking module. Wherein, the memory stores a plurality of tunnels among the networks and weights corresponding to the tunnels. The tunnel-selection module selects one of the tunnels to transmit a packet according to the weights. The tunnel-checking module checks the connectivity between the apparatus for processing the packet and the networks and adjusts the tunnel states stored in the memory according to a checking result.

In an embodiment of the present invention, the apparatus for processing the packet described above further comprises a packet encapsulation module. The packet encapsulation module is coupled to the tunnel-selection module; receives the packet transmitted from the tunnel-selection module and a data related to the tunnels; and encapsulates the packet according to the data.

The present invention also provides a method for processing a packet. The method is adapted for a packet transmission among a plurality of networks. In the method of processing the packet, weights corresponding to a plurality of present tunnels are marked. One of the tunnels is selected to transmit the packet according to the weights. After the tunnel being used is selected, the data of the selected tunnel and the packet being transmitted are encapsulated together. The encapsulated packet is then transmitted.

The above and other features of the present invention will be better understood from the following detailed description of the preferred embodiments of the invention that is provided in communication with the accompanying drawings.

### BRIEF DESCRIPTION OF THE DRAWINGS

FIG. 1A is a schematic drawing showing connectivity of a single or plural networks with plural network service providers.

FIG. 1B is a schematic drawing showing an apparatus for processing a packet according to a preferred embodiment of the present invention.

FIG. 1C is a schematic drawing showing an apparatus for processing a packet according to another preferred embodiment of the present invention.

FIG. 2 is a flowchart showing a weight circular algorithm used in the processing of a tunnel-selection module in the apparatus for processing the packet according to an embodiment of the present invention.

FIG. 3 is a flowchart showing a tunnel-checking module checking tunnel conditions according to an embodiment of the present invention.

### DESCRIPTION OF SOME EMBODIMENTS

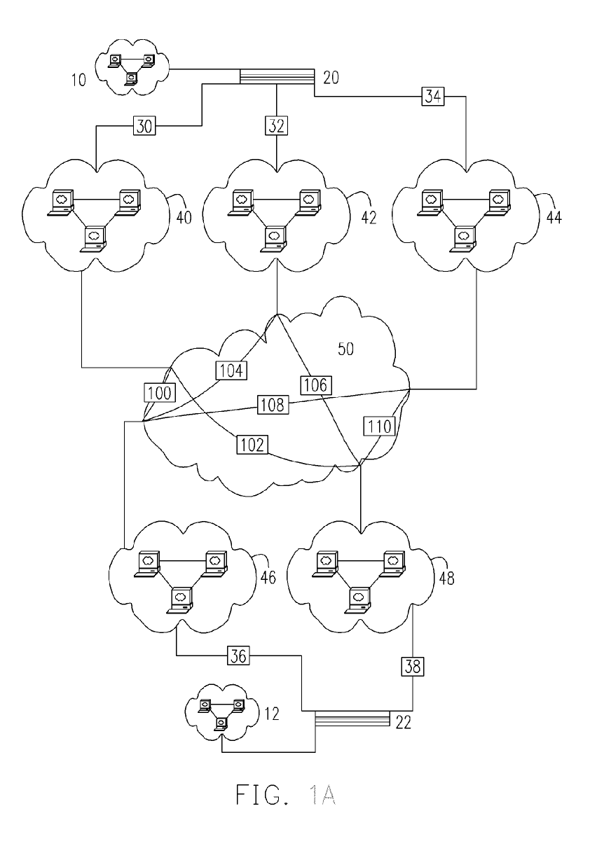

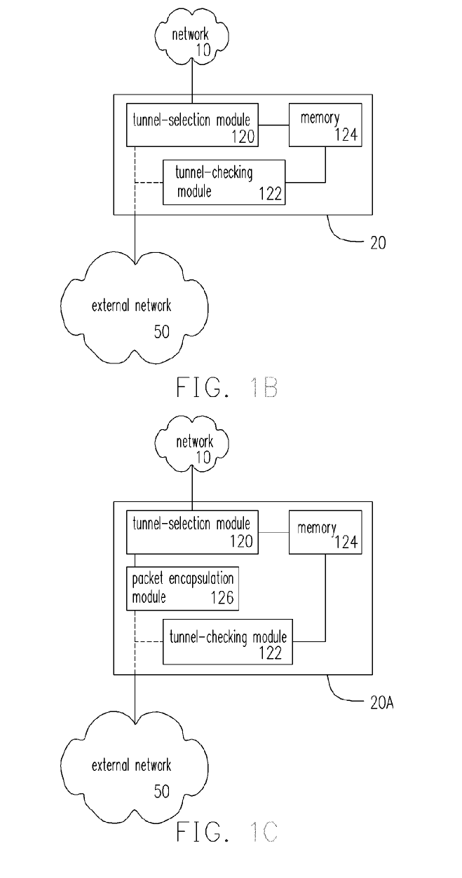

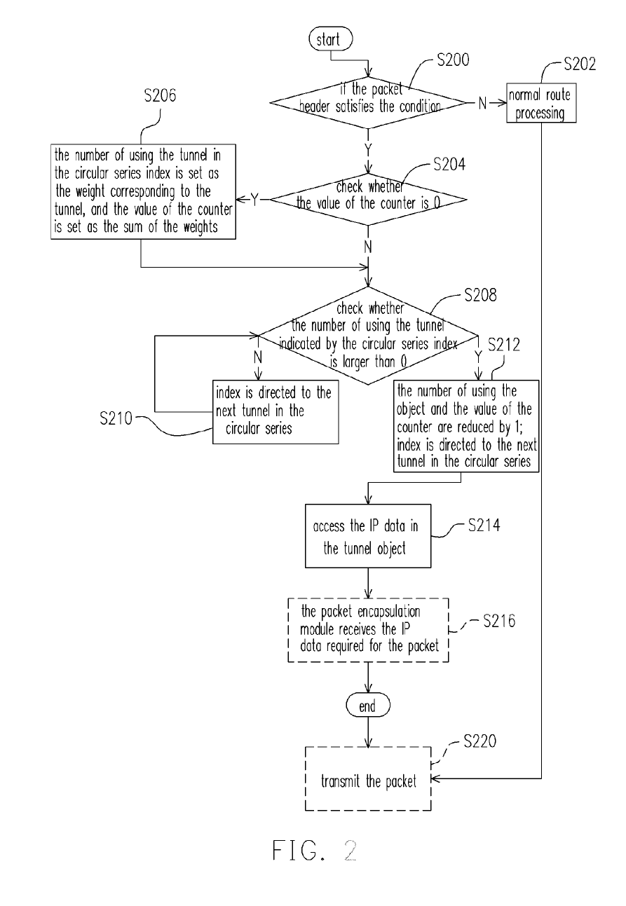

FIG. 1A is a schematic drawing showing connectivity of a single or plural networks with plural network service providers. Referring to FIG. 1A, after the apparatus 20 is triggered, according to an internal setup, all public internet protocol (IP) addresses 36 and 38 of a remote apparatus 22 and the public IP addresses 30, 32 and 34 of the apparatus 20 can be obtained. Based on these data, the apparatus 20 may establish a tunnel system to connect with the apparatus 22. The tunnel system at most comprises six tunnels 100, 102, 104, 106, 108 and 110. Since the apparatus 20 has three links, and the apparatus 22 has two links, thus two links by the three links constitute six tunnels, 100-110.

When transmitted from an apparatus in the network A of the area 10 to a receiver apparatus in the network B of the area 12, the packet should be processed by the apparatus 20. The apparatus 20 determines which route to transmit the packet to the apparatus 22.

After receiving the packet, the apparatus 22 transmits the packet to the receiver apparatus in the network B of the area 12.

In this embodiment, the apparatus 20 or 22 can be an apparatus for processing a packet according to the present invention. FIG. 1B is a schematic drawing showing an apparatus for processing a packet according to a preferred embodiment of the present invention. In this embodiment, the apparatus for processing the packet comprises a tunnel-selection module 120, a tunnel-checking module 122 and a memory 124. Wherein, the apparatus 20 processes the packet transmitted between the internal network 10 and the external network 50. The tunnel-checking module 122 checks the tunnels between the apparatus 20 and the target. In order to achieve the function described above, the memory 124 should store the data related to the tunnels 100-110 as shown in FIG. 1A. The tunnel-checking module 122 manages the tunnels. The tunnel-selection module 120 selects one of the tunnels for the packet transmission.

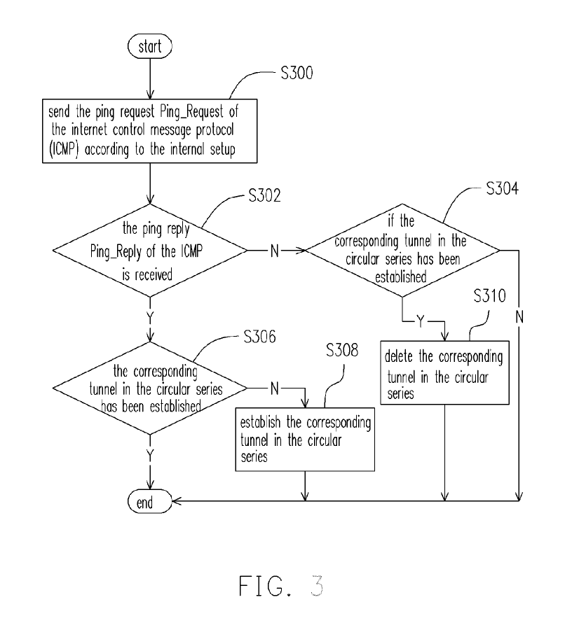

Following is detailed description of the operation of the tunnel-selection module 120. Please refer to FIGS. 1A, 1B and 2. FIG. 2 is a flowchart showing a weight circular algorithm used in the processing of a tunnel-selection module in the apparatus for processing the packet according to an embodiment of the present invention. Since the packet is transmitted to the apparatus 22 through the network 50 from the apparatus 20 in this embodiment, the apparatus 20 must first receives and processes the packet. The apparatus 20 first checks the packet header to determine that the packet is to be transmitted to the apparatus 22. The tunnel-selection module 120 in the apparatus 20 searches related tables and circular series in the memory 124 and identifies the effective tunnel objects for the tunnels 100, 102, 104, 106, 108 and 110. These tunnel objects include all public IP addresses of the apparatuses 20 and 22 connected to the tunnels represented thereto. In addition, the tunnel-selection module 120 also searches weights corresponding to the tunnels 100, 102, 104, 106, 108 and 110 stored in the memory 124. According to the weights corresponding to the tunnels, the tunnel to be used to transmit the packet is determined.

In this embodiment, first the tunnel-selection module 120 determines if the packet header satisfies the preset condition in step S200. If the packet header does not meet the preset condition, the packet will be processed by a normal route (step S202) and transmitted (step S220). If the packet header satisfies the preset condition, the method of the present invention is used to transmit the packet.

In order to successfully transmit the packet, the circular series techniques and a counter are brought in this embodiment. Wherein, each object of the circular series represents a tunnel. The serial indexes circulate in the circular series. Moreover, after the tunnel for transmitting the packet is determined, the number of using the tunnel is reduced by 1. The counter is used to maintain the correct use rate of each tunnel. For example, if the apparatus 20 comprises the tunnels 100, 102, 104, 106, 108 and 110 which have weights 4, 2, 1, 1, 2 and 4, respectively, the objects in the circular series comprise the tunnels 100, 102, 104, 106, 108 and 110. For the total fourteen transmissions, there should be 4, 2, 1, 1, 2, and 4 packet transmissions through the tunnels 100, 102, 104, 106, 108 and 110 to the apparatus 22, respectively.

In other words, after determining that the method of the present invention is used to process the packet, the tunnel-selection module first checks whether the value of the counter is 0 in step S204. If the value of the counter is 0, the number of using the tunnel in the circular series is set as the weight corresponding to the tunnel, and the value of the counter is set as the sum of the weights (step S206). Step S208 checks whether the number of using the tunnel indicated by the circular serial index is larger than 0 after the value of the counter is determined to be 0 by step S204 or after the value determined by the selected tunnel and the counter is obtained by step S206. If the number of using the tunnel is larger than 0, the tunnel is used for the packet transmission, and each of the value of the counter and the number of using the tunnel is reduced by 1 in step S212. Contrarily, if the number of using the tunnel is 0, the indication is directed to the next tunnel in the circular series in step S210. Then, step S208 is repeated for checking.

For example, if the numbers of using the tunnel objects are 4, 2, 1, 1, 2 and 4, they become 3, 1, 0, 0, 1 and 3 in the second round; 2, 0, 0, 0, 0 and 2 in the third round; and 0, 0, 0, 0, 0 and 0 in the fifth round. At this moment, the value of the counter is 0 as well. By the algorithm, the value of the counter is reset as 14, and the numbers of using the tunnel objects are reset as 4, 2, 1, 1, 2 and 4. Accordingly, the continuously circular disposition of using the tunnels according the weights can be achieved.

After the tunnel for the packet transmission is determined in step S212, the public IP addresses of both sides represented by the tunnels are transmitted to the packet encapsulation module. The packet encapsulation module can be disposed on the transmission tunnel between the tunnel-selection module 120 and the external network 50, or integrated in the tunnel-selection module 120 as shown in FIG. 1C. The packet encapsulation module adds desired packet headers as shown in steps S214 and S216. The encapsulated packet is then transmitted to a network provided by a network service provider through a specific network interface. The router in the network then transmits the packet to the apparatus 22 through the tunnel built on some links, which connects the apparatus 20 to the apparatus 22, provided by network service provider.

FIG. 3 is a flowchart showing a tunnel-checking module checking tunnel conditions according to an embodiment of the present invention. In this embodiment, the tunnel-checking module sends the ping request Ping_Request of the internet control message protocol (ICMP) according to the internal setup of the apparatus for processing the packet in step S300. After the transmission of the Ping_Request, the tunnel-checking module holds a moment to determine if the corresponding ping reply Ping_Reply is received in step S302. If the ping reply Ping_Reply is received, it means that the tunnel exists and should be stored in the circular series in the memory as shown in steps S306 and S308.

Contrarily, if no ping reply Ping_Reply is received, it means that the tunnel does not exist and should be removed from the circular series in the memory as shown in steps S304 and S310.

By the method of the present invention, the tunnel-checking module deletes the invalid tunnel object from the tables and the circular series in the memory. After the interrupted connectivity is recovered and a tunnel is therefore established, the newly established tunnel and related data can be added in the tables and circular series to form one of the tunnel objects in the memory. Accordingly, the tunnel-checking module can correctly and timely maintain the number and contexts of the tunnels. The tunnel-selection module also selects the desired tunnel for the packet transmission.

According to the detailed descriptions above, the objects and advantages of the present invention are clear. These embodiments described above do not limit the scope of the present invention. On the contrary, the present invention may include various modifications of these embodiments, such as different data structures, selection algorithms, or package encapsulation standards.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

1. An apparatus for processing a packet, the apparatus being coupled among a plurality of networks, the apparatus for processing the packet comprising:
a memory, storing a plurality of tunnels among the networks and weights corresponding to the tunnels;
a tunnel-selection module, selecting one of the tunnels to transmit a packet according to the weights; and
a tunnel-checking module, checking connectivity between the apparatus for processing the packet and the networks, and adjusting the tunnels stored in the memory according to a checking result.

2. The apparatus for processing a packet of claim 1, further comprising:
a packet encapsulation module, coupled to the tunnel-selection module, the packet encapsulation module receiving the packet transmitted from the tunnel-selection module and a data related to the selected tunnel, and encapsulating the packet according to the data.

3. The apparatus for processing a packet of claim 2, wherein the packet encapsulation module is installed in the tunnel-selection module.

4. A method for processing a packet, transmitting the packet among a plurality of networks, the method comprising:
a. marking weights corresponding to a plurality of present tunnels;
b. selecting one of the tunnels to transmit the packet according to the weights;
c. encapsulating a data of the selected tunnel and the packet; and
d. transmitting the encapsulated packet.

5. The method of claim 4, further comprising:
determining whether a packet header of the packet meets a preset condition after the packet is received, and using the method for processing the packet, if the packet header of the packet meets the preset condition.

6. The method of claim 4, wherein the step a comprises:
checking tunnel conditions of the networks;
deleting a non-existing part of the tunnels if the non-existing part of the tunnels is not found;
adding a new tunnel into the tunnels if the new tunnel is created; and
assigning a weight corresponding to each of the tunnels existed.

7. The method of processing a packet of claim 4, wherein the step b comprises:
b1. using each tunnel as an object of a circular series, a sum of the weights of the tunnels serving as a value of a counter, a weight corresponding to one of the tunnels as a number of using the tunnel;
b2. circularly using the tunnels; after using one of the tunnels, deducting a number of using the tunnel by 1; after transmitting one packet, reducing the value of the counter by 1; and
b3. repeating the step b1 after resetting the value of the counter to set up another numbers of using the tunnels and another value of the counter.
